(19) United States
(12) Patent Application Publication
(10) Pub. No.: US 2012/0285496 A1
(43) Pub. Date: Nov. 15, 2012

(54) DISHWASHER SPRAY ASSEMBLY

(75) Inventors: Joel Charles Boyer, Louisville, KY (US); Errin Gnadinger, Louisville, KY (US); Satish Kumar Raju Buddharaju, Louisville, KY (US); Michael Goodman Schroeder, Columbus Grove, OH (US)

(73) Assignee: GENERAL ELECTRIC COMPANY, Schenectady, NY (US)

(21) Appl. No.: 13/103,381

(22) Filed: May 9, 2011

(51) Int. Cl. A47L 15/23; B05B 1/26; A47L 15/22

(52) U.S. Cl. 134/56 D; 239/461

(57) ABSTRACT

A spray assembly for an automatic dishwasher is described. The spray assembly includes a conduit for receiving pressurized washing liquid. The spray assembly further includes a spray body having two or more spray arms. Each spray arm has a plurality of orifices for distributing washing liquid throughout the dishwasher. The spray arms share a common central axis and are generally planar with one another. The spray arms each define a separate fluid path from the conduit to the orifices that is separated from the other fluid path(s) by one or more walls.

### FIELD OF THE INVENTION

The present disclosure relates to a dishwasher appliance having a spray assembly.

### BACKGROUND OF THE INVENTION

This disclosure relates to dishwashing machines of the type used in households and commercial settings having upper and lower racks within which are arranged articles to be washed. Ordinarily the lower rack is loaded with larger size plates, pots and pans, and the like, and the upper rack is particularly designed to carry the smaller dishes, cups and glassware. Such dishwashing machines normally have one or more spray arms which rotate on a horizontal plane having orifices or jet holes which spray the washing and rinsing liquid upwardly and or downwardly against the dishes in the racks thereabove or therebelow depending on the location of the arm itself. One or more of these orifices or jet holes may be positioned so that the water streams issuing therefrom cause the spray arm itself to rotate thereby achieving maximum coverage of the dishes by the washing liquid.

One of the problems associated with present spray arms, and associated water jets, is that they typically have issues with balancing coverage. Present spray arms, and associated water jets, can also have issues with mechanical wash action.

The utilization of multiple spray arm assemblies seeks to address these issues. However, multiple spray arm assemblies can increase system complexity. In addition, multiple spray arm assemblies can cause higher system flow loss due to multiple joint leakages and can also result in increases to overall system volume.

Accordingly, a single spray arm assembly that has increased coverage with better mechanical action as well as better coverage balance would be useful. A spray arm assembly having multiple, separate spray paths within a single spray arm assembly would be particularly useful.

### BRIEF DESCRIPTION OF THE INVENTION

Aspects and advantages of the disclosure will be set forth in part in the following description, or may be obvious from the description, or may be learned through practice of the disclosure.

In certain embodiments of the present disclosure, a spray assembly for an automatic dishwasher is described. The spray assembly includes a conduit for receiving pressurized washing liquid. The spray assembly further includes a spray body having two or more spray arms. Each spray arm has a plurality of orifices for distributing washing liquid throughout the dishwasher. The spray arms share a common central axis with one another. The spray arms each define a separate fluid path from the conduit to the orifices that is separated from the other fluid path(s) by one or more walls.

In still other embodiments of the present disclosure, an automatic dishwasher is described. The automatic dishwasher has a tub for receiving articles to be washed and a spray assembly for distributing washing liquid in the interior of the tub. The spray assembly includes a conduit for receiving pressurized washing liquid. The spray assembly further includes a spray body having two or more spray arms. Each spray arm has a plurality of orifices for distributing washing liquid throughout the dishwasher. The spray arms share a common central axis with one another. The spray arms each define a separate fluid path from the conduit to the orifices that is separated from the other fluid path(s) by one or more walls.

These and other features, aspects and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 provides a front view of a dishwasher appliance in accordance with certain aspects of the present disclosure.

FIG. 2 provides a side view of the dishwasher appliance of FIG. 1. A portion of the cabinet is removed to reveal the interior of the dishwasher—including portions of a spray arm assembly in accordance with certain aspects of the present disclosure.

FIG. 3 is a perspective view of a dishwasher spray arm assembly in accordance with certain aspects of the present disclosure.

FIG. 4 is a cross-sectional view of a dishwasher spray arm assembly in accordance with certain aspects of the present disclosure.

FIG. 5 is a bottom view of a conduit and spray body of a spray assembly in accordance with certain aspects of the present disclosure.

FIG. 6 is a cross-sectional view of the conduit and spray body of a spray arm assembly of FIG. 5 in accordance with certain aspects of the present disclosure.

### DETAILED DESCRIPTION OF THE INVENTION

The present disclosure relates to a dishwasher appliance having a spray arm assembly that can provide balanced coverage and mechanical wash action. The spray arm assembly includes a conduit for receiving pressurized washing liquid and a spray body having two or more spray arms which each define separate fluid paths. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

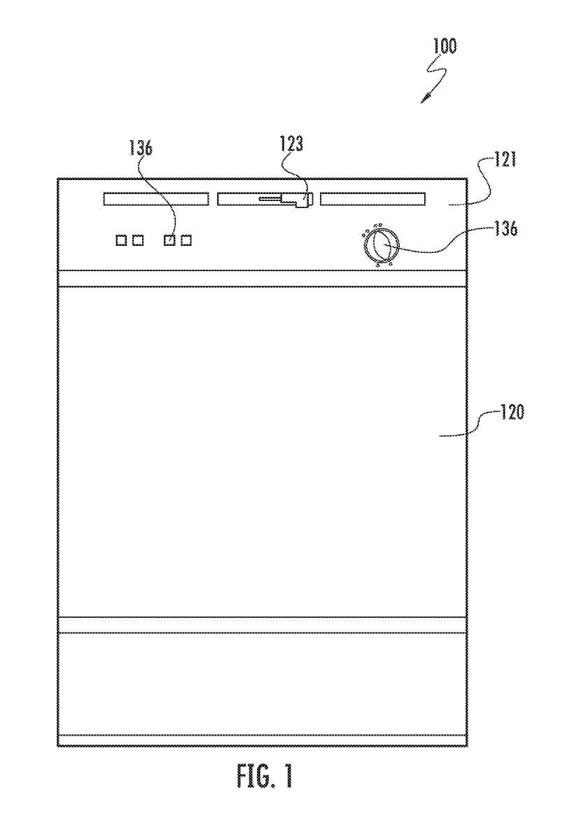

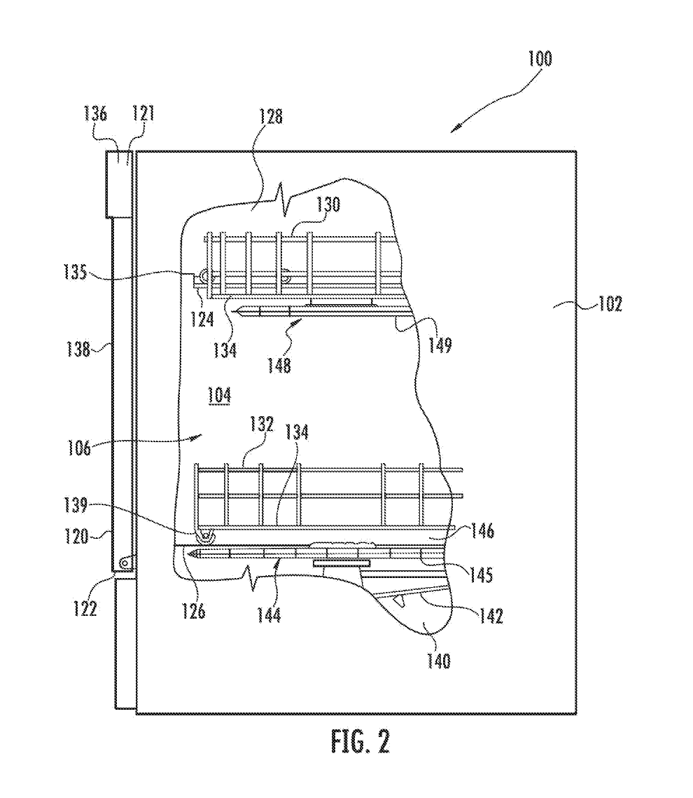

FIGS. 1 and 2 depict an exemplary domestic dishwasher 100 that may be configured in accordance with aspects of the present disclosure. For the particular embodiment of FIG. 1, the dishwasher 100 includes a cabinet 102 having a tub 104 therein that defines a wash chamber 106. The tub 104 includes a front opening (not shown) and a door 120 hinged at its bottom 122 for movement between a normally closed vertical position (shown in FIGS. 1 and 2), wherein the wash chamber 106 is sealed shut for washing operation, and a horizontal open position for loading and unloading of articles from the dishwasher. Latch 123 is used to lock and unlock door 120 for access to chamber 106.

Upper and lower guide rails 124, 126 are mounted on tub side walls 128 and accommodate upper and lower roller-equipped rack assemblies 130, 132, respectively. Each of the upper and lower racks 130, 132 is fabricated into lattice structures including a plurality of elongated members 134. Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106. This is facilitated by rollers 135 and 139, for example, mounted onto racks 130 and 132, respectively. A silverware basket (not shown) may be removably attached to the lower rack 132 for placement of silverware, utensils, and the like, that are too small to be accommodated by the upper and lower racks 130, 132.

The dishwasher 100 is further equipped with a controller (not shown) to regulate operation of the dishwasher 100. The controller may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller may be positioned in a variety of locations throughout dishwasher 100. In the illustrated embodiment, the controller may be located within a control panel area 121 of door 120 as shown. In such an embodiment, input/output (“I/O”) signals may be routed between the control system and various operational components of dishwasher 100 along wiring harnesses that may be routed through the bottom 122 of door 120. Typically, the controller includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller via one or more signal lines or shared communication busses.

The dishwasher 100 further includes a lower spray-arm assembly 144 that can be rotatably mounted within a lower region 146 of the wash chamber 106 and above a tub sump portion 142 so as to rotate in relatively close proximity to the lower rack 132. A mid-level spray-arm assembly 148 is located in an upper region of the wash chamber 106 and may be located in close proximity to upper rack 130. Additionally, an upper spray arm assembly (not shown) may be located above the upper rack 130.

The lower and mid-level spray-arm assemblies 144, 148 and the upper spray arm assembly are fed by a fluid circulation assembly for circulating water and dishwasher fluid in the tub 104. The fluid circulation assembly may be located in a machinery compartment 140 located below the bottom sump portion 142 of the tub 104, as generally recognized in the art. Each spray-arm assembly includes an arrangement of discharge ports or orifices for directing washing liquid onto dishes or other articles located in the upper and lower racks 130, 132, respectively. The arrangement of the discharge ports in at least the lower spray-arm assembly 144 can provide a rotational force by virtue of washing fluid flowing through the discharge ports. The resultant rotation of the lower spray-arm assembly 144 provides coverage of dishes and other dishwasher contents with a washing spray. Certain embodiments of the lower spray-arm assembly 144, mid-level spray arm assembly 148, and upper spray arm assembly in accordance with the present disclosure will now be further detailed. In particular, the spray arm assemblies described herein can provide balanced coverage and mechanical wash action.

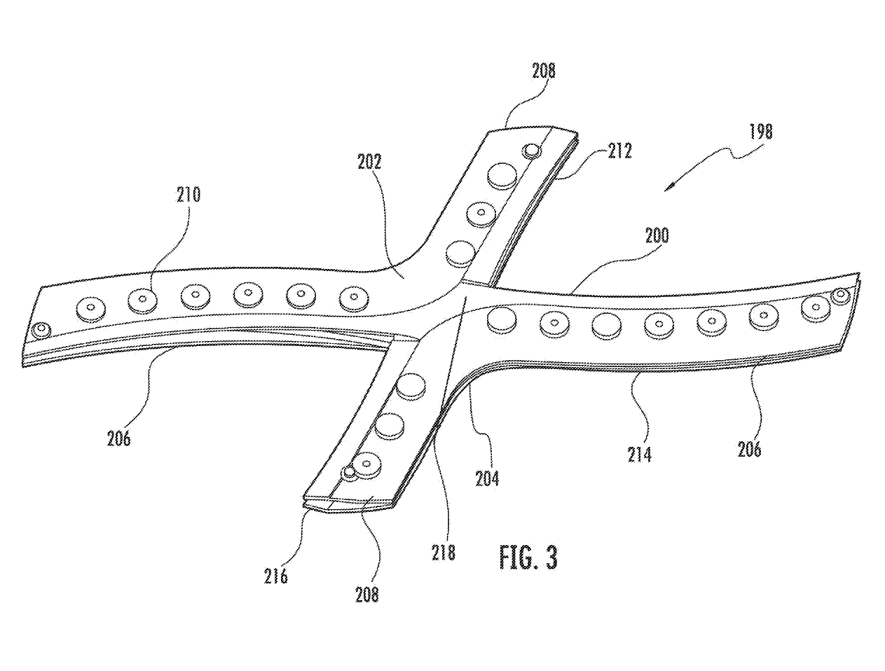

Referring to FIG. 3, a perspective view of a spray arm assembly 198 in accordance with certain aspects of the present disclosure is illustrated. The spray arm assembly includes spray body 200 having top surface 202 and bottom surface 204 which are generally formed from two or more spray arms. In addition, one or more side surfaces 205 join the top surface 202 and bottom surface 204. As illustrated, spray body 200 includes first spray arm 206 and second spray arm 208, although additional spray arms are also contemplated by the present disclosure.

As illustrated, spray arms 206, 208 are generally elongated and include top surfaces 210 and 212, respectively, and bottom surfaces 214 and 216, respectively. Each spray arm extends across central axis 218 and, as illustrated, can be include two generally symmetrical ends portions. Each spray arm is mated into singular spray body 200 at a common central axis 218 and is generally planar with the other spray arm(s). In this regard, generally planar refers to any degree of curvature or angle between the respective spray arms which still allows such spray arms to rotate properly within a dishwasher. Similarly, each spray arm has a length and width of suitable size to be properly accommodated by a dishwasher as would be understood by one of ordinary skill in the art. In addition, each of the spray arms can have different sizes and shapes in an effort to gain optimal coverage area in the dishwasher.

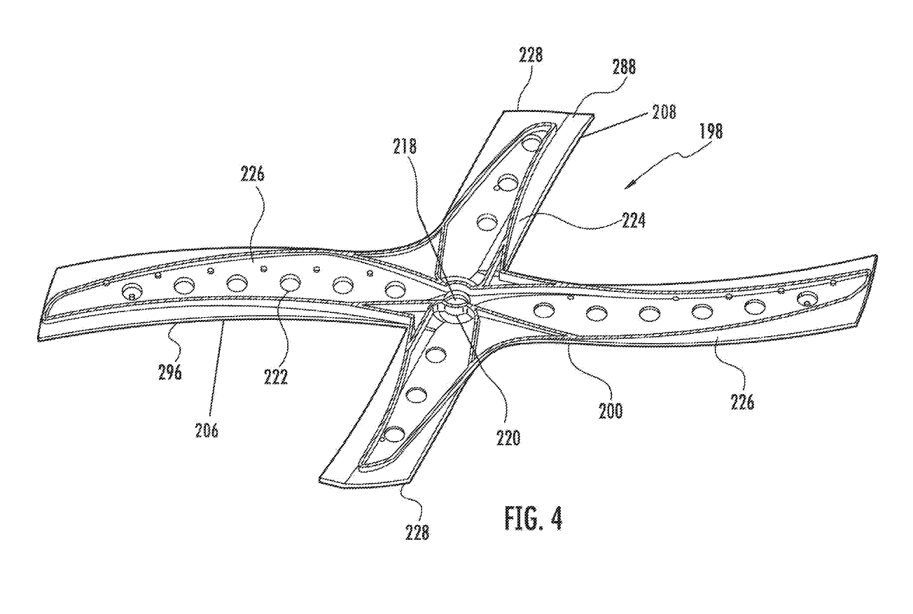

Turning to FIG. 4, a cross-sectional view of spray arm assembly 198 is illustrated in accordance with certain aspects of the present disclosure. Spray arm assembly 198 also includes conduit 220 which is coupled with spray body 200 adjacent to central axis 218. Conduit 220 can be joined in any suitable manner with spray body 200 such that spray body 200 including spray arms 206, 208 can rotate about central axis 218. For instance, conduit 220 can be rotatably coupled with spray body 200.

Generally, pressurized washing liquid flows through one or more inlets of conduit 220 into spray body 200. Each spray arm 206, 208 defines a separate and distinct fluid path 226, 228, respectively, from conduit 220 to one or more orifices 222, 224, respectively. Orifices are distributed along one or both surfaces of each spray arm or one or both end portions and can vary in number at different locations of spray arm. For instance, top portion may have more orifices than bottom portion, or the like, depending in what type of coverage is sought. In addition, orifices can be designed to generate spray in a variety of shapes and sizes as would be appreciated by those of ordinary skill in the art. For instance, certain orifices can generate a fan jet (for more coverage) when washing fluid is distributed therefrom while other orifices can generate a pencil jet (for better mechanical wash action) when washing fluid is distributed therefrom. In addition, any other suitable jet including square shaped jets and/or any irregularly shaped jet can be utilized to take advantage of changes in flow rate and/or angle.

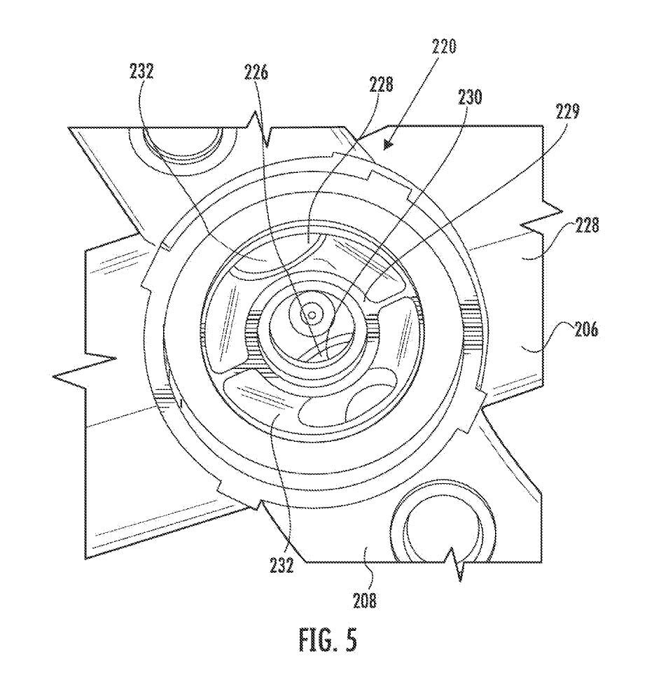

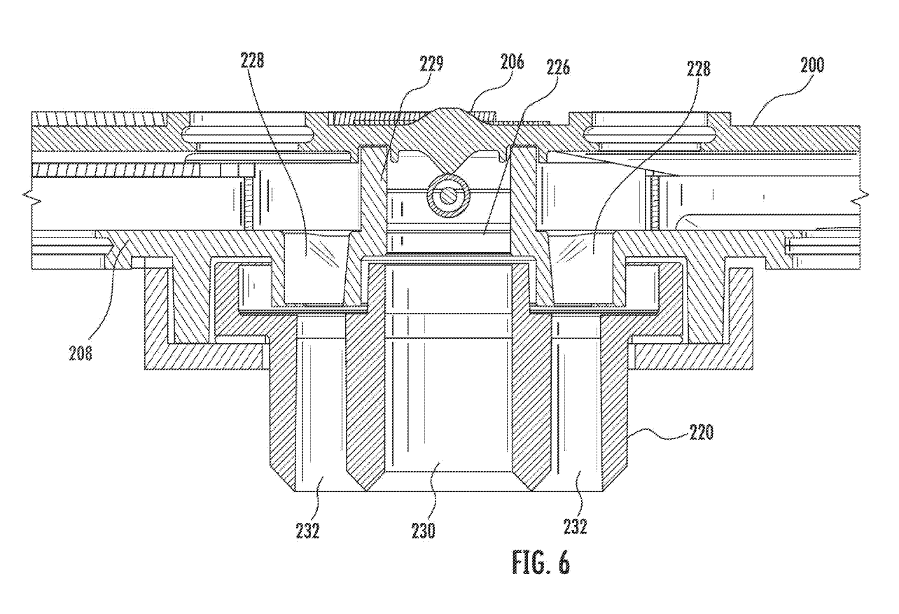

Referring to FIGS. 5 and 6, fluid paths 226, 228 are separated from one another by one or more walls 229. As described previously, conduit 220 can direct streams of washing liquid through one or more inlets into spray body 200 and fluid paths 226, 228. As illustrated, conduit 220 includes a primary flow inlet 230 and secondary flow inlets 232 with such inlets being positioned to direct separate streams of washing liquid to each fluid path 226, 228 defined by spray arms 206, 208, respectively.

Conduit 220 supplies arm 206 through primary flow inlet 230 while arm 208 is supplied through secondary flow inlets 232. As illustrated, primary flow inlet 230 is centrally positioned adjacent to central axis while secondary flow inlets 232 are concentrically positioned around primary flow inlet 230. In certain embodiments, primary flow inlet 230 can supply the arm with the highest orifice area while secondary flow inlet can supply the arm with the next highest flow area. Similarly, additional inlets can be added to conduit to supply additional arms as would be understood by one of ordinary skill in the art.

The conduit illustrated can also allow for selective diversion of washing liquid. Washing liquid can be selectively fed to one or more inlets to the exclusion of other inlets as would be understood by one of ordinary skill in the art. In this manner, washing liquid can be fed to one or more spray arms through their respective fluid paths while being withheld from the separate fluid paths of one or more other spray arms. In certain embodiments, different spray paths (depending on factors including spray arm shape and size and/or orifice shape and size as further described herein) can be utilized to induce different directions of spin for spray body. For example, a first fluid path can cause clockwise rotation of spray body while a second fluid path can cause counter clockwise rotation of the same spray body. Alternatively, or in conjunction with other embodiments described herein, orifices on each spray arm can be angled differently to gain optimal coverage or different size and/or shaped orifices can be utilized for different fluid paths to address the issue of varied loading patterns in a dishwasher.

Mating two or more fluid paths into a singular spray body can address the issues of balancing coverage and mechanical wash action. In certain embodiments, the spray assembly of the present disclosure can eliminate the need for the upper spray arm assembly described previously.

It should be appreciated that the invention is not limited to any particular style, model, or other configuration of dishwasher, and that the embodiments depicted in the FIGS. 1-5 is for illustrative purposes only. For example, instead of the racks 130, 132 depicted in FIG. 1, the dishwasher 100 may be of a known configuration that utilizes drawers that pull out from the cabinet and are accessible from the top for loading and unloading of articles. Other configurations may be used as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A spray assembly for an automatic dishwasher, comprising:
a conduit for receiving pressurized washing liquid; and
a spray body, the spray body comprising two or more spray arms with each spray arm having a plurality of orifices for distributing washing liquid throughout the dishwasher, the spray arms sharing a common central axis with one another, the spray arms each defining a separate fluid path from the conduit to the orifices that is separated from the other fluid path(s) by one or more walls.

2. A spray assembly as in claim 1, wherein the conduit includes more than one inlet, the inlets configured to direct separate streams of washing liquid to each fluid path defined by each spray arm.

3. A spray assembly as in claim 1, wherein the spray body is rotatable about the central axis.

4. A spray assembly as in claim 3, wherein the plurality of orifices in at least one spray arm is configured to cause clockwise rotation of spray body when washing liquid is distributed therefrom and wherein a plurality of orifices in at least one other spray arm is configured to cause counter clockwise rotation of spray body when washing liquid is distributed therefrom.

5. A spray assembly as in claim 1, wherein at least one spray arm has an upper surface, lower surface, and one or more side surfaces and the plurality of orifices is formed in the upper surface, lower surface, one or more side surfaces or combinations thereof.

6. A spray assembly as in claim 1, wherein at least one spray arm has at least one orifice that is configured to generate a pencil jet, fan jet, or combinations thereof when washing fluid is distributed therefrom.

7. A spray assembly as in claim 1, wherein at least one spray arm has at least one orifice that is configured to generate a pencil jet or fan jet when washing fluid is distributed therefrom, or wherein at least one spray arm has greater than one orifice that are configured to generate a pencil jet, fan jet, or combinations thereof, respectively, when washing fluid is distributed therefrom.

8. A spray assembly as in claim 1, wherein at least one spray arm has at least one orifice that is square shaped or irregularly shaped.

9. A spray assembly as in claim 1, wherein at least one spray arm has at least one orifice that is configured to generate a jet at a first angle when washing fluid is distributed therefrom and wherein at least one other spray arm has at least one orifice that is configured to generate a jet at a second angle when washing fluid is distributed therefrom, the first angle being different from the second angle.

10. A spray assembly as in claim 1, wherein the conduit defines an inlet comprising a portion of the available open area of the conduit which is configured to supply a first stream of washing liquid to at least one fluid path defined by a spray arm and wherein the conduit further defines a second inlet comprising the remaining portion of the open area of the conduit which is configured to supply a second stream of washing liquid to at least one other fluid path defined by a different spray arm.

11. An automatic dishwasher having a tub for receiving articles to be washed and a spray assembly for distributing washing liquid in the interior of the tub, the spray assembly comprising:
a conduit for receiving pressurized washing liquid; and
a spray body, the spray body comprising two or more spray arms with each spray arm having a plurality of orifices for distributing washing liquid throughout the dishwasher, the spray arms sharing a common central axis with one another, the spray arms each defining a separate fluid path from the conduit to the orifices that is separated from the other fluid path(s) by one or more walls.

12. An automatic dishwasher as in claim 11, wherein the conduit includes more than one inlet, the inlets configured to direct separate streams of washing liquid to each fluid path defined by each spray arm.

13. An automatic dishwasher as in claim 11, wherein the spray body is rotatable about the central axis.

14. An automatic dishwasher as in claim 13, wherein the plurality of orifices in at least one spray arm is configured to cause clockwise rotation of spray body when washing liquid is distributed therefrom and wherein a plurality of orifices in at least one other spray arm is configured to cause counter clockwise rotation of spray body when washing liquid is distributed therefrom.

15. An automatic dishwasher as in claim 11, wherein at least one spray arm has an upper surface and a lower surface and the plurality of orifices is formed in the upper surface, lower surface, or combinations thereof.

16. An automatic dishwasher as in claim 11, wherein at least one spray arm has at least one orifice that is configured to generate a pencil jet when washing fluid is distributed therefrom.

17. An automatic dishwasher as in claim 11, wherein at least one spray arm has at least one orifice that is configured to generate a fan jet when washing fluid is distributed therefrom.

18. An automatic dishwasher as in claim 11, wherein at least one spray arm has at least one orifice that is configured to generate a pencil jet when washing fluid is distributed therefrom and wherein at least one other spray arm has at least one orifice that is configured to generate a fan jet when washing fluid is distributed therefrom.

19. An automatic dishwasher as in claim 11, wherein at least one spray arm has at least one orifice that is configured to generate a jet at a first angle when washing fluid is distributed therefrom and wherein at least one other spray arm has at least one orifice that is configured to generate a jet at a second angle when washing fluid is distributed therefrom, the first angle being different from the second angle.

20. An automatic dishwasher as in claim 11, wherein the conduit defines a central inlet which is configured to supply a first stream of washing liquid to at least one fluid path defined by a spray arm and wherein the conduit further defines a concentric inlet about the central inlet, the concentric inlet being configured to supply a second stream of washing liquid to at least one other fluid path defined by a different spray arm.
